(19) United States
(12) Patent Application Publication
(10) Pub. No.: US 2013/0226906 A1
(43) Pub. Date: Aug. 29, 2013

(54) System And Method For A Self-Configuring Question Answering System

(71) Applicant: Nuance Communications, Inc., (US)

(72) Inventors: Alexandre Lebrun, Palo Alto, CA (US); Callixte Cauchois, Berkeley, CA (US); Pierre Serge Vincent Leroy, Cergy (FR); Julie Couhault, Saint Cloud (FR)

(73) Assignee: NUANCE COMMUNICATIONS, INC., Burlington, MA (US)

(21) Appl. No.: 13/768,958

(22) Filed: Feb. 15, 2013

Related U.S. Application Data
(60) Provisional application No. 61/599,367, filed on Feb. 15, 2012.

(51) Int. Cl. G06F 17/30

(52) U.S. Cl. CPC G06F 17/30864
USPC 707/722

(57) ABSTRACT

Question Answering systems can be costly and time-consuming to configure for a particular knowledge base. The proposed Question Answering receives an initial knowledge base, receives user queries without any further configuration, and self-configures based on user feedback. In one embodiment, a method of customizing a question answering system can include searching a plurality of articles based on a user query from a user received via a computer network. The method can further include delivering a set of articles, based on the searching, to the user via the computer network. The method can additionally include receiving user feedback on the set of articles from the user via the computer network. The method can also include associating a given article from among the set of articles with the user query based on the user feedback. In this manner, the proposed question answering system saves the customer resources otherwise spent on configuration.

### RELATED APPLICATION

This application claims the benefit of U.S. Provisional Application No. 61/599,367, filed on Feb. 15, 2012, the entire teachings of which are incorporated herein by reference.

### BACKGROUND OF THE INVENTION

Question answering systems provide companies (e.g., customers of the question answering service) an ability to have a computer operated system provide automated support to an end-user (e.g., a customer of the company). This allows for the company to provide service to the end-user 24 hours a day, seven days a week. Question answering systems also reduce labor costs by reserving employees for more difficult questions from the end-user.

### SUMMARY OF THE INVENTION

In one embodiment, a method of customizing a question answering system can include searching a plurality of articles, based on a user query from a user, received via a computer network. The method can further include delivering a set of articles, based on the searching, to the user via the computer network. The method can additionally include receiving user feedback on the set of articles from the user via the computer network. The method can also include associating a given article from among the set of articles with the user query based on the user feedback.

In another embodiment, the user feedback can be based on at least one of the following activities performed by the user: (a) selecting an article of the plurality of articles, (b) spending time viewing the article, (c) scrolling through the article, (d) leaving the article within a given time period after viewing the article, (e) selecting a second article, (f) making a manual user entry, or (g) returning to a previously selected article.

In another embodiment, the method can further include applying a corresponding score to each article within the set of articles based on the user feedback.

In yet another embodiment, the method can additionally include clustering user queries based on a linguistic distance being below a particular threshold. The method can further include associating a first cluster and second cluster based on a common association with the same article. The method can additionally include presenting a representation of the clusters of user queries to a user and enabling the user to modify the cluster. Modifying the cluster can include performing at least one of the following operations: (a) mapping the cluster to a particular article, (b) creating a new article associated with the cluster, (c) deleting an article associated with the cluster, (d) connecting the cluster to a secondary user query, the secondary user query clarifying the user queries of the cluster, (e) merging a first article and a second article associated with the cluster to be one search result, (f) splitting an article associated with the cluster into a first article and a second article associated with the cluster, or (g) rewriting an article associated with the cluster. The method can also include authorizing a user to modify the cluster.

In another embodiment, the method can include presenting a dialog mode to a user. The method can also include receiving a natural language query from a user and presenting a natural language answer to the user. The natural language answer can be an article associated with a cluster. The method can further include, if more information is needed, presenting a second natural language query to the user.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a block diagram illustrating an example embodiment of an Intelligent Virtual Agent (IVA).

FIG. 1B is a block diagram of the IVA operatively coupled to a user device over the network.

FIG. 1C is a block diagram illustrating an example embodiment of the IVA employed in a dialog mode.

FIG. 2 is a flow diagram illustrating an example embodiment of training the IVA.

FIG. 3A is a block diagram illustrating an example embodiment of the IVA in an encapsulated search mode.

FIG. 3B is a block diagram illustrating an example embodiment of the IVA employed in dialog mode.

FIG. 4A is a flow diagram illustrating an example embodiment of the IVA employed in encapsulated search mode.

FIG. 4B is a flow diagram illustrating an example embodiment of dialog mode employed by the IVA.

FIG. 5 is a block diagram illustrating an example embodiment of clusters mapping to a knowledge base.

FIG. 6 illustrates a computer network or similar digital processing environment in which the present invention may be implemented.

FIG. 7 is a diagram of the internal structure of a computer (e.g., client processor/device or server computers) in the computer system of FIG. 6.

### DETAILED DESCRIPTION OF THE INVENTION

A description of example embodiments of the invention follows.

The teachings of all patents, published applications and references cited herein are incorporated by reference in their entirety.

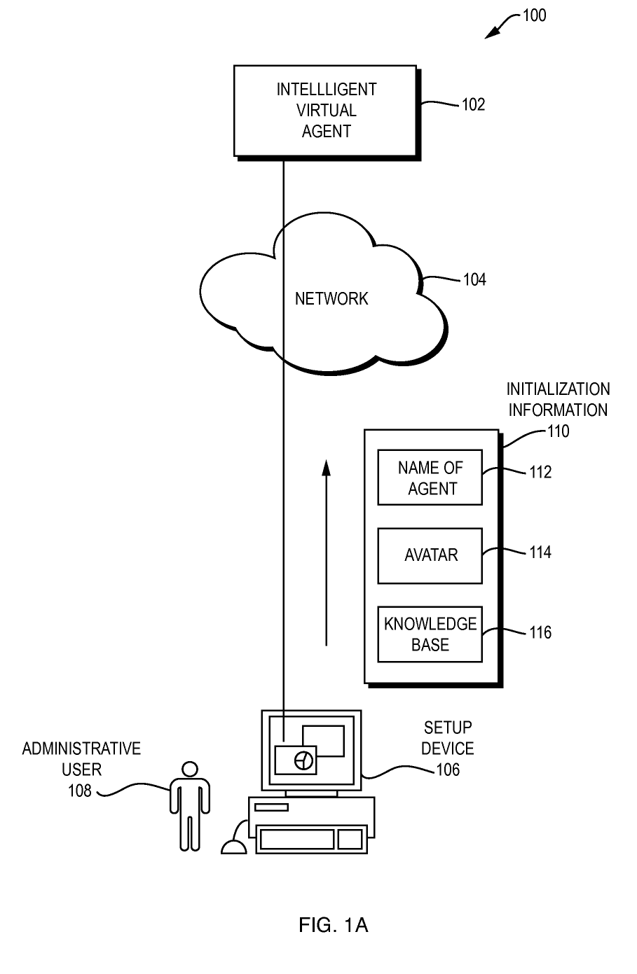

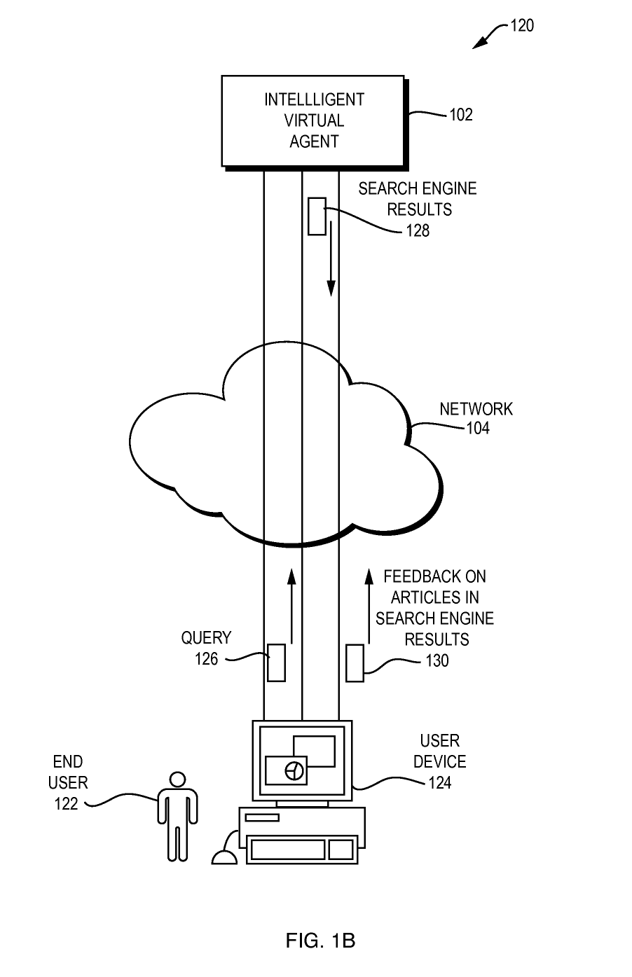

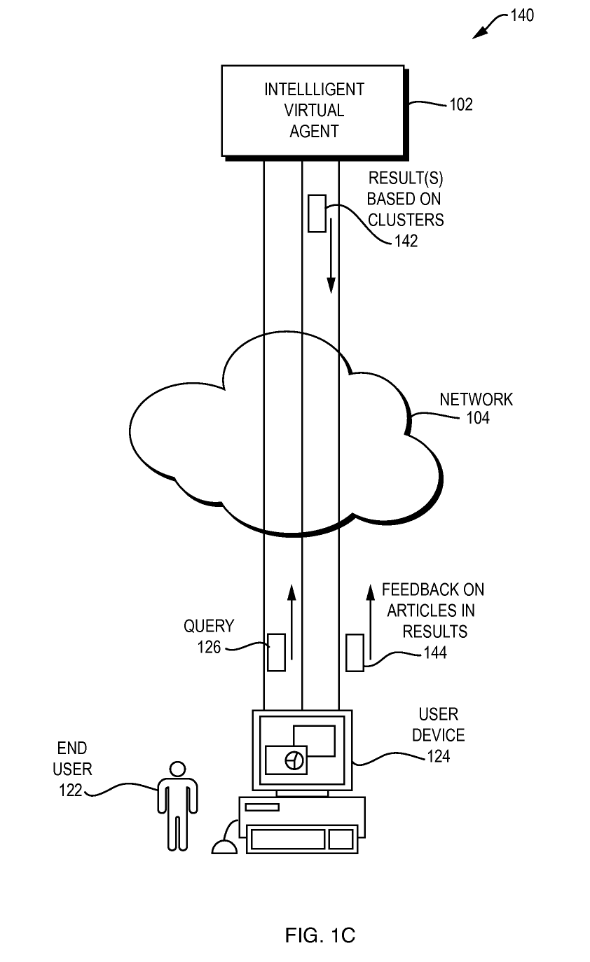

FIG. 1A is a block diagram 100 illustrating an example embodiment of an Intelligent Virtual Agent (IVA) 102. An IVA is an automated question answering system deployed by a customer (e.g., a company) that receives queries from an end-user (e.g., a client of the customer). IVAs can require a large amount of work from a vendor (e.g., a company implementing the IVA) and the customer (e.g., a company purchasing the IVA service to solve a problem, such as support, sales or marketing). In the foregoing description, customer refers to the party running the IVA, vendor refers to the party building the IVA, and end-user refers to the client of the customer that is using the IVA for support.

Quality of an IVA is linked to the quality and amount of configuration of the IVA. An IVA should issue quality answers with a precise scope with a clean content architecture. Configuring the IVA to meet these requirements bridges the gap between intent of end-user queries issued to the IVA and the content of the customer. The proposed method and corresponding system configures an IVA with a customer's knowledge base without a huge investment of time before deploying the IVA.

An administrative user 108 employs a setup device 106 to configure the IVA 102. The setup device 106 is operatively coupled to the IVA 100 over a network 104. The administrative user 108 employs the setup device 106 to send initialization information 102 to the IVA 102. The initialization information 110 includes a name of the agent 112, an avatar 114, and a knowledge base 116.

The name of the agent 112 is a name shown to end-users when conversing with the IVA 102. Likewise, the avatar 114 is a picture, such as an image of a human face or a cartoon of a human face, shown to the end-user while communicating with the IVA 102. The knowledge base 116 is a collection of articles from the customer that can be provided as answers to user queries.

FIG. 1B is a block diagram 120 of the IVA 102 operatively coupled to a user device 124 over the network 104. An end-user 122 enters a query into the user device 124 that is forwarded over the network 104 to the IVA 102. The IVA processes the query 126 by performing a search engine search of the knowledge base and delivering search engine results 128 to the user device 124 over the network 104. The user device 124 shows the search engine results 128 to the end-user 122. The end-user 122, after interacting with the search engine results 128, sends feedback 130 on the articles in the search engine results to the IVA 122. The IVA 102 then updates mapping of queries to articles in the knowledge base based on the feedback 130. Feedback 130 can include metrics such as the end-user 122 selecting (e.g., clicking on) an article, the end-user 122 leaving an article and selecting another article, the end-user 122 manually entering positive or negative feedback about an article, time spent viewing an article, scrolling within an article, or returning to a previously viewed article.

FIG. 1C is a block diagram 140 illustrating an example embodiment of the IVA 102 employed in a dialog mode. The IVA 112 in dialog mode maps queries directly to articles, instead of performing a search engine search on the knowledgebase. For example, the end-user 122 enters a query 126 into the user device 124. The IVA 102, upon receiving the query 126, instead of performing a search engine search, directly maps the query 126 in an article or a set of articles, and delivers result(s) based on clusters 142 to the user device 124. Likewise, the user device then delivers feedback 144 on articles in the results, similar to the feedback 130 described in FIG. 1B.

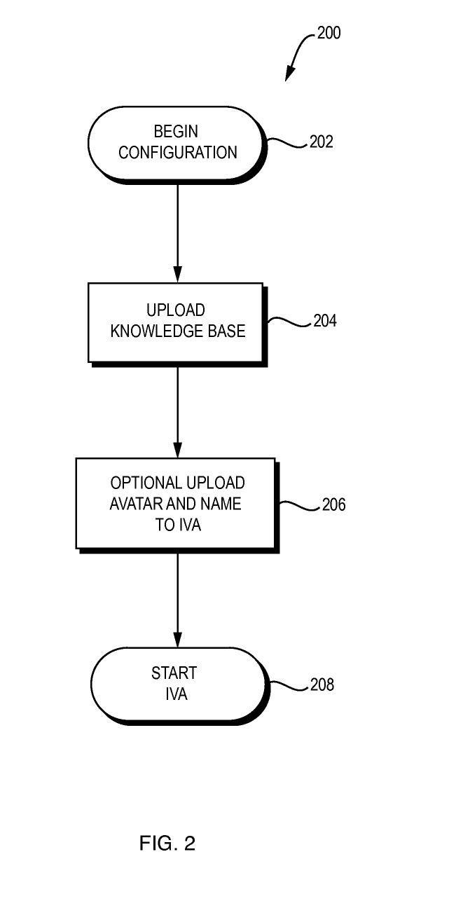

FIG. 2 is a flow diagram 200 illustrating an example embodiment of training the IVA. Training begins by beginning configuration (202). Then, the user uploads a knowledge base to the IVA (204). Then, the user can optionally upload an avatar and a corresponding name to the IVA (206). Then, the configuration is complete and the user can start the IVA for interaction with end-users (208).

In one embodiment, the IVA begins with a database of the customer's content “as is.” The customer is able to create and educate the IVA without help from the vendor. Content can include answers taken from frequently asked questions (FAQs), resolution cards, solutions, etc. The customer's content “as is” is known to be bad, and embodiments of the systems and methods disclosed herein aim to improve the content in the database. The IVA provides a search experience to end-users using the database of the customer content “as is.” The IVA monitors behavior and final satisfaction of end-users, and modifies the database accordingly to improve future IVA performance.

In one embodiment, the IVA described herein can be deployed on its host website and exposed to users as soon as the IVA is created. The customer organization is able to immediately provide its users with an IVA user interface (UI) (e.g., a chat window) on its website by adding code (e.g., JavaScript, HTML5, etc.). IVA creation, from the customer perspective, includes selecting a name for the IVA, an avatar for the IVA, and linking the system to its knowledge base. In other embodiments, the IVA can be created without a name and/or avatar.

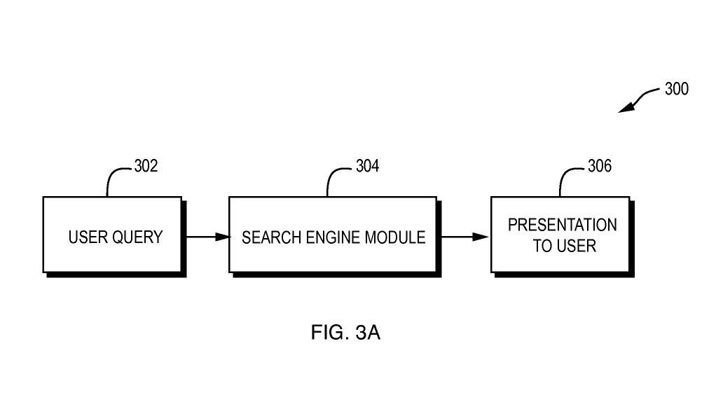

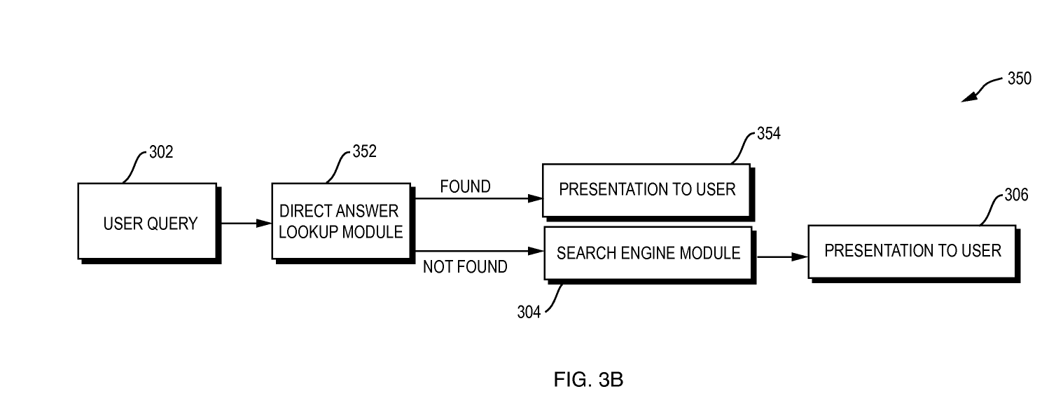

FIG. 3A is a block diagram 300 illustrating an example embodiment of the IVA in an encapsulated search mode. A search engine module 304 within the IVA receives a user query 302. The search engine module 304 performs a search of the knowledge base, based on the words in the user query 302, and delivers a presentation to the user 306. The presentation to the user 306 can include a set of articles that are most closely related to the user query 302 based on the words in the user query 302.

Upon deployment, the IVA is in encapsulated search mode, using a search engine on the customer's knowledge base to provide its response to end-user queries. At this point, the IVA relies on no other data to provide its responses to the query other than words within the customer's knowledge base. In encapsulated search mode, the behavior of the end-user using the UI of the IVA is recorded. The IVA records the queries of the user, the articles/links the user chooses to click, the time the user spends on each linked page, the user's satisfaction, either self-reported by use of thumbs up and thumbs down buttons or by implication. Implied user satisfaction can be measured by a user's leaving an article, or by retaining knowledge of the last article a user visits.

The IVA, during the encapsulated search phase, sends every user input to its search engine which responds with a series of possible articles. The IVA presents selected top ranked articles to the user as potential responses. The IVA also adds links between the user query and the selected articles with a neutral grade. If an article is already linked with the query, the grade of the article in the IVA system does not change. The IVA links user queries to knowledge base articles (or other answers) based on the grades. The IVA, in discovering the possible links between user queries and knowledge base articles, can then later ask the administrative user of the customer to confirm or reject the links/mapping.

For example, after the end-user enters query q₁=“can I send a check?,” the IVA search engine returns four articles: a₁₂₃, a₅₈₇, a₇₄₅ and a₄₅₇. At this point, grades of all the articles are zero, as indicated by the following equation (with L(qₖ,aₙ) being the grade of the link between qₖ and aₙ):

L(q₁,a₁₂₃)=L(q₁,a₅₈₇)=L(q₁,a₇₄₅)=L(q₁,a₄₅₇)=0

From there, the IVA records end-user actions reacting to the presented articles. Each action can assign a number of points to the link between a query and an article (L(qₖ,aₙ)). In one embodiment, an end-user's clicking a link adds five points to the grade between the article and the query. Similarly, an end-user's clicking a “thumbs up” adds 10 points to the grade, and the end-user's clicking a “thumbs down” subtracts 10 points from the grade. For example, if the end-user selects the first article (a₁₂₃), clicks on “thumbs down” for the same first article (a₁₂₃), returns to the search screen, click on third one and “thumbs up” and leave gives the following point totals for the links:

L(q₁,a₁₂₃)=−5

L(q₁,a₅₈₇)=0

L(q₁,a₇₄₅)=+15

L(q₁,a₄₅₇)=0

Other user input, such as scrolling the article, time spent on the article, or leaving the article, can also be recorded and modify the grade accordingly. The IVA monitors user input and adjusts the grades of the links for every end-user query.

FIG. 3B is a block diagram 350 illustrating example embodiment of the IVA employed in dialog mode. In dialog mode, a direct answer lookup module 352 receives the user query 32. The direct answer lookup module 352 employs data in the IVA based on previously received user feedback to link the user query 302 directly to an article or a set of articles and delivers the articles in a presentation to the user 354, if such a link is found. On the other hand, if the link is not found, the direct answer lookup module relays the user query to the search engine module 304, which performs a search as described in FIG. 3A. In relation to FIG. 3B, the search engine module 304 then delivers the presentation 306 to the end-user as described in relation to FIG. 3A. This can be referred to as a “search fallback,” where. in the event that the IVA does not successfully find a helpful article for the end-user, the IVA can offer a search of the knowledge base/database based on the user query.

The IVA switches to dialog mode after a threshold of volume of traffic to the IVA. The IVA UI does not change from the perspective of the user in dialog mode. However, instead of querying the search engine to provide the responses, the IVA can map a user input directly to an intent and to a response or article. If the IVA cannot map the input to an intent, or if the IVA cannot map the intent to a response, then the IVA performs a search of the knowledge base, as described above. In the dialog mode, the behavior of the end-user continues to be recorded, as described above, in order to further refine the IVA's knowledge of the end-user's intents.

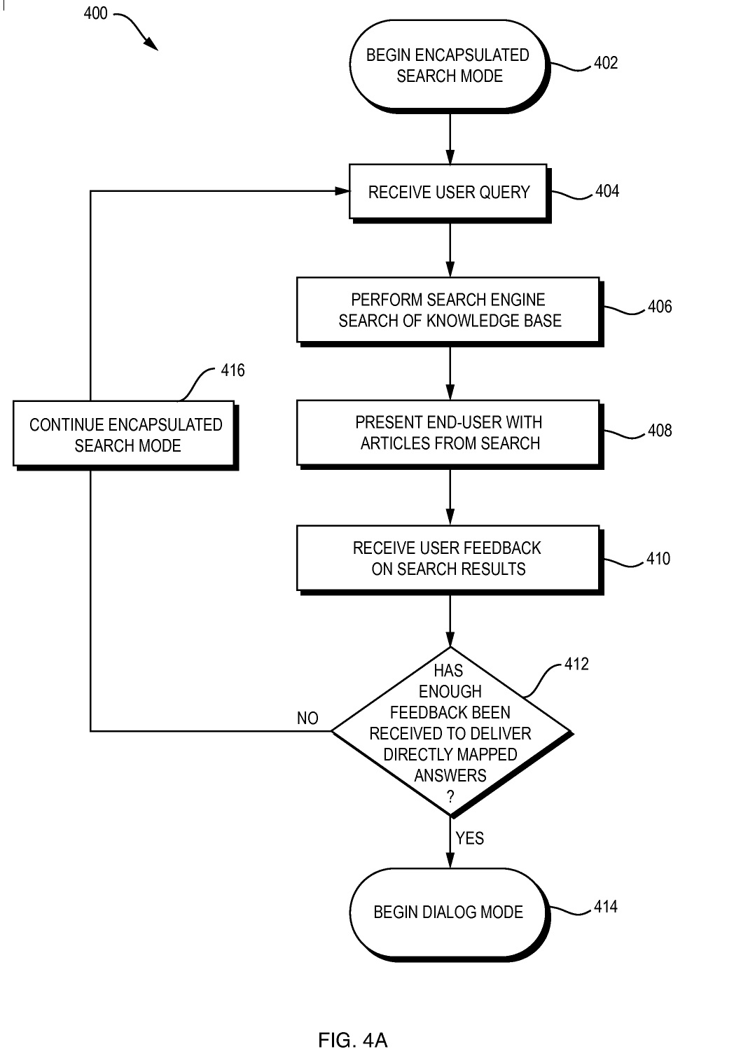

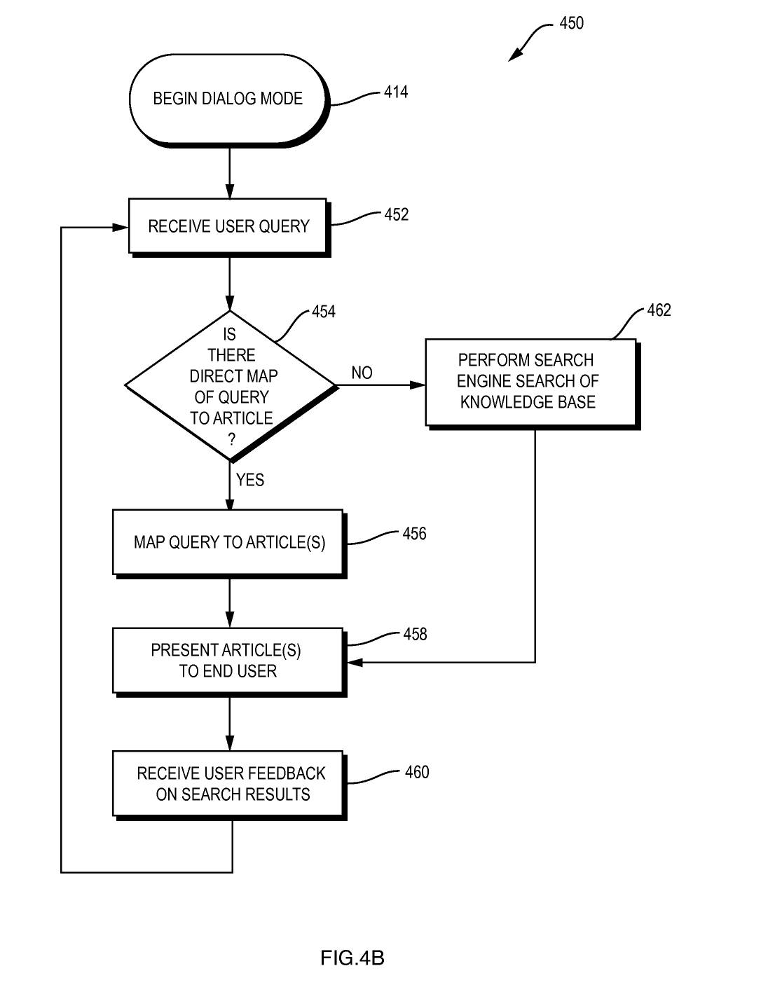

FIG. 4A is a flow diagram 400 illustrating example embodiment of the IVA employed in encapsulated search mode. First, the IVA begins the encapsulated search mode (402). The IVA receives a user query (404). Then, the IVA performs a search engine search of the knowledge base with the words in the user query (406). The IVA then presents the end-user with articles found from the search (408). The articles found in the search can be ranked according to matches with the words in the query or another metric. Then, the IVA receives user feedback on the search results (410). The IVA, based on the user feedback, adjusts scores of the articles in relation to the query received for future mapping of the query to each article in the search results. Then the IVA determines whether enough feedback has been received to deliver directly mapped answers to the user query (412).

If enough feedback has been received, the IVA begins dialog mode (414). Dialog mode is further described in relation to FIG. 4B. In relation to FIG. 4A, if the IVA determines that there is not enough feedback received to deliver directly mapped answers to the user (412). The IVA continues the encapsulated search mode (416), and then receives a subsequent user query (404).

FIG. 4B is a flow diagram 450 illustrating an example embodiment of dialog mode employed by the IVA. The IVA begins dialog mode (414) after the encapsulated search mode has been complete (FIG. 4A). In relation to FIG. 4B, the IVA then receives the user query (452). Then, the IVA determines whether there is a direct map of a query to an article (454). If there is a direct map to an article (454), then the IVA maps the query to the article or articles (456). Then, the IVA presents the articles to the end-user (458). The IVA receives user feedback on the search results to update the links further between queries and articles, even though encapsulated search mode is over (460). Then, the IVA receives another user query (452).

On the other hand, if there is no direct map of a query to an article (454), the IVA performs a search engine search of the knowledge base (462). Then, the IVA presents the articles to the end-user (458).

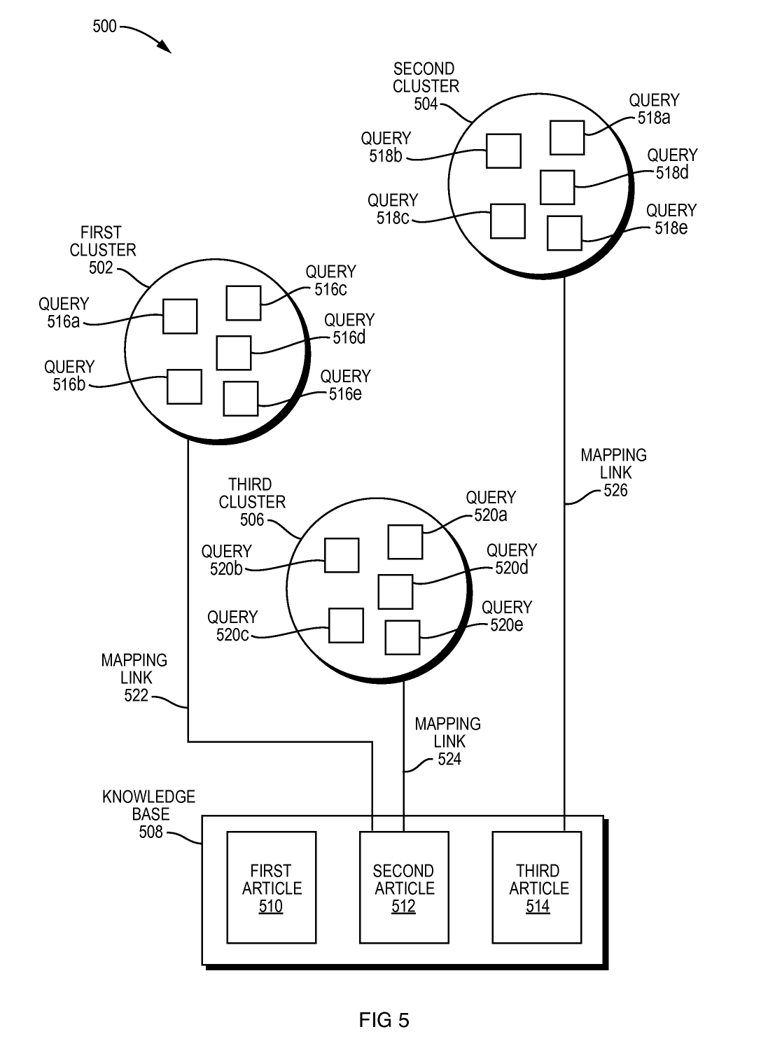

FIG. 5 is a block diagram 500 illustrating an example embodiment of clusters mapping to a knowledge base 508. In the background, on a regular basis, the IVA reviews all the end-user queries it receives. The IVA clusters the queries by grouping them by their linguistic proximity. The IVA clusters end-user queries with the same meaning together. Clustering is further described in “Semantic Clustering” by Jean-Marie Larchavêque et al., filed as U.S. application Ser. No. 12/758,091 on Mar. 26, 2010 and “Semantic Clustering and Conversational Agents” by Jean-Marie Larchavêque et al., filed as U.S. application Ser. No. 12/748,2010 on Mar. 26, 2010, both of which are incorporated herein by reference in their entirety.

If d(qᵢ,qⱼ) is the linguistic distance between qᵢ and qⱼ and Q is the entire query space, linguistic clusters can be defined as follows:

∀qεQ,∃cCQ,∀(q₁,q₂)εc²,d(q₁,q₂)<ε and qεc

The operation creates a set of disjoint clusters mapping the entire query space Q. The clusters can be assigned links to the articles, the grade of the links being a function of the grades of the links of the cluster's contained queries, as described by the following relationship.

Λ(cₙ,aₘ)=f(L(qᵢ,aₘ),qⱼεcₙ)

The above function accounts for links not existing exist between some queries in the cluster and a particular article. As a result, each cluster has a preferred article which is the article whose link has the highest grade, noted as a(cₙ). The IVA, during the second pass of clustering, groups linguistic clusters that have the same preferred article. The clusters can also be referred to as intent.

C(aₖ)={q,qεcₙ and a(cₙ)=aₖ}

Links and grades on the dual clusters are defined the same as links and grades for linguistic clusters. Although dual clusters can be defined by a preferred article, the clusters are linked to multiple lower ranked articles, and the Λ function (a→Λ(C,a)) is defined for the lower ranked articles in addition to the preferred article.

Dual approach clustering combines groups queries by both linguistic aspects of the query but also by the end-user's intent (as reflected by the grades of the links). Dual approach clustering combines two ways of ascertaining the meaning of an incoming query: (1) its local linguistic data, and (2) what the end-user previously indicated is an appropriate response.

A first cluster 502, second cluster 504, and third cluster 506 include a plurality of queries 516a-e, 518a-e, and 520a-e. Each of the clusters 502, 504 and 506 map to articles in the knowledge base 508. For example, the first cluster 502 maps, via a mapping link 522, to a second article 512 in the knowledge base 508. The mapping link 522 is based on feedback of the queries 516a-e within the first cluster 502 that indicate the second article 512 is most relevant to the topic of the queries 516a-e stored in first cluster 502.

Further, the third cluster 506 includes a mapping link 524 also to the second article 512. The mapping link 524, like the mapping link 522, is based on the queries 520a-e within the third cluster 506. The IVA, based on the first cluster 502 and third cluster 506 both mapping to the second article 512, can suggest to merge the first cluster 502 and third cluster 506. The IVA suggests merging the first cluster 502 and third clustering 506 because the respective queries 516a-e and 520a-e of both clusters indicates that the second article 512 is an answer to both. This implies that the first cluster 502 and the queries 516a-e therein and the third cluster 506 and the queries 520a-e therein includes similar queries that may be simply worded differently and not graded same by a linguistic search, but are about the same content.

The second cluster 504, which includes queries 518a-e, is mapped to a third article 514 via mapping link 526. The second cluster 504 is not a candidate for merging because no other cluster maps to the same third article 514. The knowledge base 508 also includes first article 510 to which no cluster has a mapping link.

Each cluster 502, 504 and 506 can map to multiple articles in addition to mapping to one article. A cluster mapping to one article is shown in FIG. 5 for simplicity. Each cluster can map to multiple articles, having a top-ranked article and other lower-ranked articles to display to the user. Further, a cluster can map to no article if the queries have not indicated to which article the queries map.

Further, the IVA can issue other suggestions to the customer to improve the end-user experience. For example, the IVA can suggest that the customer improve content by creating or deleting answers. The IVA can further suggest creating refining questions to hone in on an end-user query. The IVA can also map intents of a query directly to a known solution. The IVA can additionally offer suggestions to the organization, such as the rewriting of an article, merging of two similar articles (as described above), and splitting of an answer into two different articles.

The IVA can include an administrative tool for the customer's use, which can prompt an administrative user of the customer to take one or more actions to improve the IVA's content. These actions are presented simply to the administrative user, for example, by requiring only one click to perform the action.

One action provided by the administrative tool is “Map.” The administrative tool presents the administrative user with a list of end-user inputs and a knowledge base article. The administrative tool asks the administrative user to enter whether each input on the list should trigger this article as a response.

The administrative tool can also ask the administrative user to merge two similar articles, split an article into two if queries with two or more different subjects commonly result in the same article, rewrite an article, create an article if a cluster is mapped to no article or no article with a rank above a certain threshold, or delete an article that is mapped to no cluster or has no rank for any cluster or query above a certain threshold.

The IVA can also detect the need for clarification between two articles. If two articles need clarification, the administrative tool can ask the administrative user to create a clarifying question to be presented to the user. The clarifying question should elicit the user's intent to discriminate between these two articles. Therefore, the IVA can evolve into more than a question answering system by being able to handle more complex dialog guided by detecting the need for clarification and adapting the dialog with the administrator-generated clarifying question.

In one embodiment, when the customer needs to take an action, the administrative tool presents example user inputs to the administrative user that the IVA detected before proposing the action. This presents the decision for the administrative user as whether the administrative wants the IVA responding to the user query as shown, as opposed to making decisions abstractly. For example, the administrative tool can ask the administrative user to determine whether “Question A” should map to “Article X,” and the administrative user can answer with a “yes” or “no.”

As soon as the IVA has initiated dual clustering, the IVA reviews the clusters and their respective links to articles to propose enhancement in the knowledge of the agent to the customer. For every cluster C, the IVA employs the A function (a→Λ(C,a)), and the distribution of its results are the signals to select which (if any) suggestion to make. A good solution for a cluster C and a corresponding article a is determined if its grade Λ(C,a) is greater than a threshold (t), where G_{c} is the set of the good solutions for cluster C.

G_{c}={a,Λ(C,a)<t}

Let also /G_{c}/ be the cardinal (i.e., indicate the number of articles it contains) of this set.

| | Suggestions | Conditions to trigger suggestion |
|---|---|---|
| Map | Connect a cluster to | /G_{c}/ = 1 |
| | an article. | |
| Create | Write a new article. | C ≠ and /G_{c}/ = 0 |
| Delete | Delete a useless | C (a) = |
| | article. | |
| Clarify | Connect a cluster to | 1 < /G_{c}/ < 4 |
| | a clarifying question. | |
| Merge | Merge two articles. | 1 < /G_{c}/ < 4 |
| Split | Split one article into | C(a) is composed of at least two linguistic |
| | two new articles. | clusters that are too distant from each other. |
| Rewrite | Rewrite an article. | C(a) is composed of at least two linguistic |
| | | clusters that are too distant from each other. |

The IVA annotates links between clusters of queries and articles based on the actions taken by the customer. The IVA then uses those annotations in dialog mode. Once enough of the query space is mapped to articles or clarifying questions the agent can be switched into dialog mode. In this mode, when a user inputs a query, the IVA attempts to determine to which cluster C the end-user's query belongs. There are three possibilities:
1) The IVA finds a cluster and the cluster is mapped to an article or a clarifying question, and the IVA responds the article or clarifying question. If the user is not happy with the provided response, the user has the option of using the search engine, for example, via a “see more answers button.”
2) The IVA finds a cluster that is not mapped to an article or clarifying question. The IVA responds with articles contained in G_{c}.
3) The IVA cannot find a cluster, so the IVA employs the search engine to find an article.

In this mode, the IVA continues to employ behavior monitoring, clustering and guided evolution in the background so that the IVA is continuously improved.

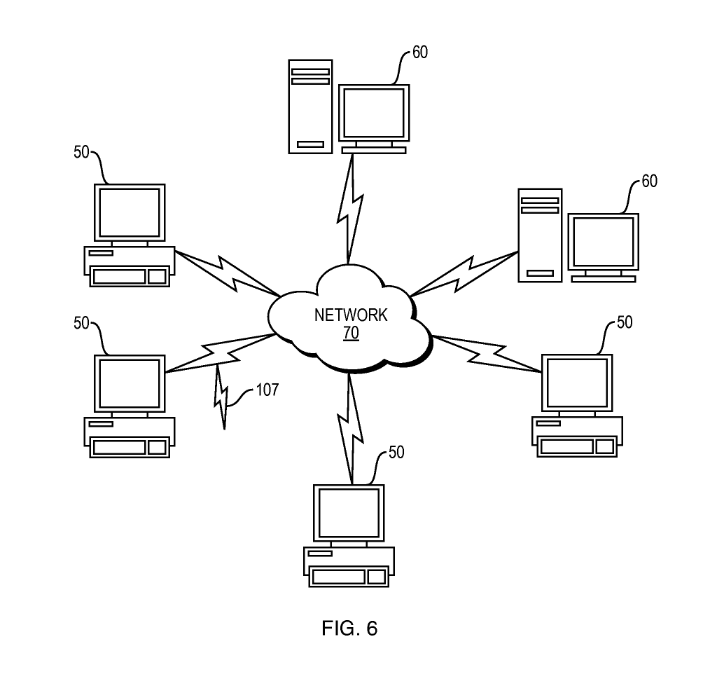

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

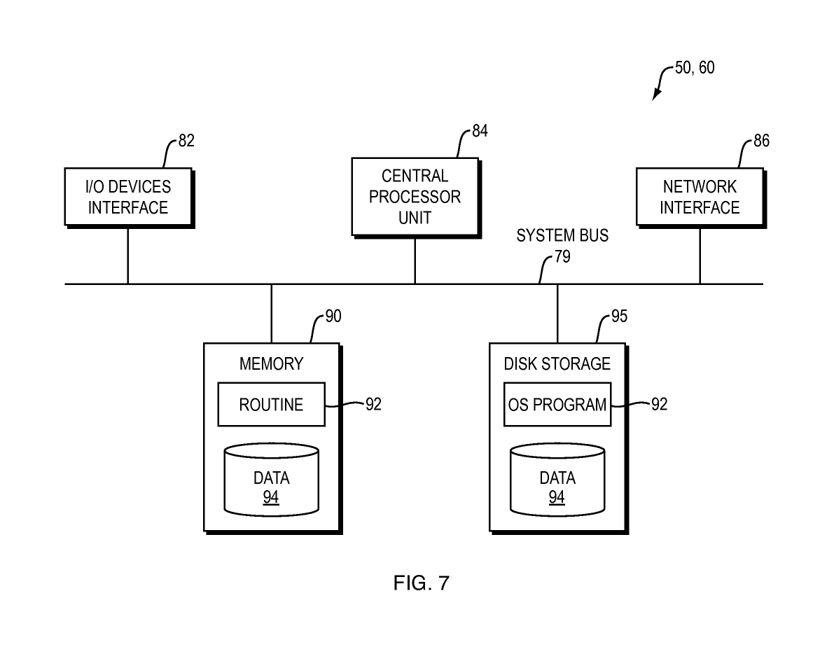

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention (e.g., IVA implementing code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to example embodiments thereof, it will be understood by those skilled in the art that various changes in form and details may be made therein without departing from the scope of the invention encompassed by the appended claims.

What is claimed is:

1. A method of customizing a question answering system comprising:
searching a plurality of articles based on a user query from a user received via a computer network;
delivering a set of articles, based on the searching, to the user via the computer network;
receiving user feedback on the set of articles from the user via the computer network; and
associating a given article from among the set of articles with the user query based on the user feedback.

2. The method of claim 1, wherein the user feedback is based on at least one of the following activities performed by the user:
selecting an article of the plurality of articles;
spending time viewing the article;
scrolling through the article;
leaving the article within a given time period after viewing the article;
selecting a second article;
making a manual user entry; and
returning to a previously selected article.

3. The method of claim 1, further comprising:
applying a corresponding score to each article within the set of articles based on the user feedback.

4. The method of claim 1, further comprising clustering user queries based on a linguistic distance being below a particular threshold.

5. The method of claim 4, further comprising:
associating a first cluster and second cluster based on a common association with the same article.

6. The method of claim 4, further comprising:
presenting a representation of the clusters of user queries to a user; and
enabling the user to modify the cluster.

7. The method of claim 6, wherein modifying the cluster includes performing at least one of the following operations:
mapping the cluster to a particular article.
creating a new article associated with the cluster;
deleting an article associated with the cluster;
connecting the cluster to a secondary user query, the secondary user query clarifying the user queries of the cluster;
merging a first article and a second article associated with the cluster to be one search result;
splitting an article associated with the cluster into a first article and a second article associated with the cluster; and
rewriting an article associated with the cluster.

8. The method of claim 7, further comprising authorizing a user to modify the cluster.

9. The method of claim 1, further comprising presenting a dialog mode to a user.

10. The method of claim 9, further comprising:
receiving a natural language query from a user; and
presenting a natural language answer to the user, the natural language answer being an article associated with a cluster, or, if more information is needed, presenting a second natural language query to the user.

11. A system for customizing a question answering system comprising:
a search module configured to search a plurality of articles based on a user query from a user received via a computer network;
an articles module configured to deliver a set of articles, based on the searching, to the user via the computer network and receive user feedback on the set of articles from the user via the computer network; and
an association module configured to associate a given article from among the set of articles with the user query based on the user feedback.

12. The system of claim 11, wherein the user feedback is based on at least one of the following activities performed by the user:
selecting an article of the plurality of articles;
spending time viewing the article;
scrolling through the article;
leaving the article within a given time period after viewing the article;
selecting a second article;
making a manual user entry; and
returning to a previously selected article.

13. The system of claim 11, wherein the association module is further configured to apply a corresponding score to each article within the set of articles based on the user feedback.

14. The system of claim 11, further comprising a clustering module configured to cluster user queries based on a linguistic distance being below a particular threshold.

15. The system of claim 14, wherein the association module is further configured to associate a first cluster and second cluster based on a common association with the same article.

16. The system of claim 14, further comprising a user interface module configured to present a representation of the clusters of user queries to a user and enable the user to modify the cluster.

17. The system of claim 16, wherein modifying the cluster includes performing at least one of the following operations:
mapping the cluster to a particular article.
creating a new article associated with the cluster;
deleting an article associated with the cluster;
connecting the cluster to a secondary user query, the secondary user query clarifying the user queries of the cluster;
merging a first article and a second article associated with the cluster to be one search result;
splitting an article associated with the cluster into a first article and a second article associated with the cluster; and
rewriting an article associated with the cluster.

18. The system of claim 17, wherein the user interface module is further configured to authorize a user to modify the cluster.

19. The system of claim 10, further comprising a user interface module configured to present a dialog mode to a user.

20. The system of claim 19, wherein the user interface module is further configured to receive a natural language query from a user and present a natural language answer to the user, the natural language answer being an article associated with a cluster, or, if more information is needed, presenting a second natural language query to the user.
